(19) United States
(12) Patent Application Publication
(10) Pub. No.: US 2011/0004708 A1
(43) Pub. Date: Jan. 6, 2011

(54) COMPUTER APPARATUS AND PATH MANAGEMENT METHOD

(75) Inventors: Atsushi Kondo, Yokohama (JP); Ryu Gemba, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/561,891

(22) Filed: Sep. 17, 2009

(30) Foreign Application Priority Data
Jul. 6, 2009 (JP) 2009-159933

(51) Int. Cl. G06F 3/00

(52) U.S. Cl. 710/38

(57) ABSTRACT

A highly-reliable computer apparatus and path management method capable of reducing the impact of a failure in a physical I/O device on the entire virtual computer system is suggested.

If a first path management unit detects a failure in a virtual HBA, it notifies a second path management unit of the failure; and in response to the failure notice, the second path management unit gives an instruction to the first path management unit corresponding to each virtual computer having another virtual HBA that uses a physical HBA corresponding to the virtual HBA in which the failure has been detected, to block the other virtual HBA; and if the first path management unit receives the instruction from the second path management unit to block the virtual HBA, it blocks the designated virtual HBA.

### CROSS-REFERENCES TO RELATED APPLICATIONS

This application relates to and claims priority from Japanese Patent Application No. 2009-159933, filed on Jul. 6, 2009, the entire disclosure of which is incorporated herein by reference.

### TECHNICAL FIELD

The present invention relates to a computer apparatus and a path management method and is ideal for use in, for example, a virtual computer system in which a physical HBA (host bus adapter) is shared by a plurality of virtual computers (hereinafter referred to as the “virtual machines”).

### BACKGROUND ART

Conventionally, a physical I/O (Input/Output) device, such as an HBA, in a virtual computer system is shared by using a virtualization program called “hypervisor” for dividing the physical I/O device into logical I/O devices and sharing them, and by assigning the execution right to a virtual machine having a path redundant program for controlling I/O devices (Japanese Patent Application Laid-Open (Kokai) Publication No. 2006-209487).

Japanese Patent Application Laid-Open (Kokai) Publication No. 2006-209487 discloses a method by which a hypervisor manages access path information between physical I/O devices for a server apparatus and virtual I/O devices for a plurality of virtual computers belonging to a server computer. Japanese Patent Application Laid-Open (Kokai) Publication No. 2006-209487 also discloses a method by which if the hypervisor detects a failure in an I/O channel, it changes the connection between the virtual I/O devices and the physical I/O devices.

### DISCLOSURE OF THE INVENTION

A failure can be detected by the method disclosed in Japanese Patent Application Laid-Open (Kokai) Publication No. 2006-209487 only when an I/O time-out occurs. Therefore, the above conventional method has a problem in that even if the occurrence of a failure has been detected in one virtual computer, I/O is delayed every time a failure is detected in another virtual computer.

The present invention was devised in light of the circumstances described above. It is an object of the invention to suggest a highly-reliable computer apparatus and path management method capable of reducing the impact of a failure in a physical I/O device on the entire virtual computer system.

In order to solve the problem described above, the present invention provides a computer apparatus that provides a virtual environment and is connected to a storage apparatus having a storage area, the computer apparatus including: a virtual computer providing unit for providing a plurality of virtual computers, each having a virtual HBA; a plurality of first path management units provided in such a manner that they are associated with the plurality of virtual computers, respectively, and each first path management unit manages the status of the virtual HBA belonging to its corresponding virtual computer; a plurality of physical HBAs that are shared by the plurality of virtual computers and correspond to the virtual HBAs; and a second path management unit for managing a correspondence relationship between the virtual HBAs belonging to the plurality of virtual computers and the plurality of physical HBAs; wherein if the first path management unit detects a failure in the virtual HBA, it notifies the second path management unit of the failure; and in response to the failure notice, the second path management unit gives an instruction to the first path management unit corresponding to each virtual computer having another virtual HBA that uses the physical HBA corresponding to the virtual HBA in which the failure has been detected, to block the other virtual HBA; and if the first path management unit receives the instruction from the second path management unit to block the virtual HBA, it blocks the designated virtual HBA.

Moreover, the invention provides a path management method for a computer apparatus that provides a virtual environment and is connected to a storage apparatus having a storage area, the computer apparatus including: a virtual computer providing unit for providing a plurality of virtual computers, each having a virtual HBA; a plurality of first path management units provided in such a manner that they are associated with the plurality of virtual computers, respectively, and each first path management unit manages the status of the virtual HBA belonging to its corresponding virtual computer; a plurality of physical HBAs that are shared by the plurality of virtual computers and correspond to the virtual HBAs; and a second path management unit for managing a correspondence relationship between the virtual HBAs belonging to the plurality of virtual computers and the plurality of physical HBAs; wherein if the first path management unit detects a failure in the virtual HBA, it notifies the second path management unit of the failure; and in response to the failure notice, the second path management unit gives an instruction to the first path management unit corresponding to each virtual computer having another virtual HBA that uses the physical HBA corresponding to the virtual HBA in which the failure has been detected, to block the other virtual HBA; and if the first path management unit receives the instruction from the second path management unit to block the virtual HBA, it blocks the designated virtual HBA.

If a failure occurs in a path, each virtual computer is notified of the failure and the path routed through a physical I/O where the failure has occurred in each virtual computer is blocked according to this invention. As a result, the invention can make it possible to avoid a delay caused by the path failure.

### BRIEF DESCRIPTION OF THE DRAWINGS

FIG. 1 is a block diagram of the entire configuration of a virtual computer system according to an embodiment of the present invention;

FIG. 2 is a diagram explaining information stored in a memory for a physical computer shown in FIG. 1;

FIG. 3 is a block diagram of the logical configuration of the virtual computer system shown in FIG. 1;

FIG. 4 is a conceptual diagram explaining a first path management table;

FIG. 5 is a conceptual diagram explaining a second path management table;

FIG. 6 is a block diagram explaining a path management function according to this embodiment;

FIG. 7 is a flowchart illustrating a processing sequence for path management program activation processing;

FIG. 8 is a conceptual diagram explaining VM information;

FIG. 9 is a flowchart illustrating a processing sequence for path management table creation processing;

FIG. 10 is a conceptual diagram explaining HBA information;

FIG. 11 is a flowchart illustrating a processing sequence for guest OS activation processing;

FIG. 12 is a flowchart illustrating a processing sequence for path failure dealing processing;

FIGS. 13A to 13C are conceptual diagrams explaining the path failure dealing processing;

FIG. 14 is a flowchart illustrating a processing sequence for path recovery processing;

FIGS. 15A to 15C are conceptual diagrams explaining the path recovery processing;

FIG. 16 is a flowchart illustrating a processing sequence for virtual machine hibernation processing;

FIG. 17 is a flowchart illustrating a processing sequence for the path failure dealing processing during hibernation;

FIG. 18 is a flowchart illustrating a processing sequence for virtual machine resume processing; and

FIG. 19 is a conceptual diagram explaining the first path management table.

### BEST MODE FOR CARRYING OUT THE INVENTION

An embodiment of the present invention will be explained below in detail with reference to the attached drawings.

### (1) Configuration of Virtual Computer System according to This Embodiment

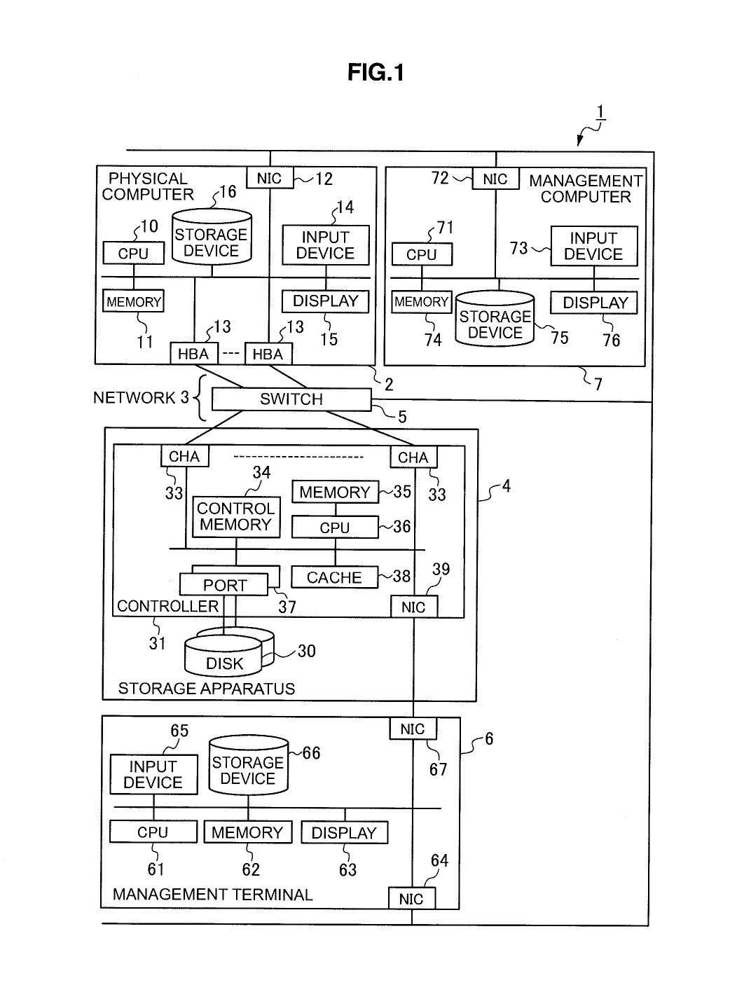

Reference numeral “1” in FIG. 1 represents the physical configuration of a virtual computer system as a whole according to an embodiment of the present invention. This virtual computer system 1 is configured so that a physical computer 2 is connected via a network 3 to a storage apparatus 4.

This virtual computer system 1 is constituted from the physical computer 2, the storage apparatus 4, a switch 5 (network 3), a management terminal 6, and a management computer 7. The physical computer 2 and the storage apparatus 4 are connected to the switch 5 (network 3). Also, the physical computer 2, the management terminal 6, and the switch 5 are connected via, a LAN 27, to the management computer 7. Referring to FIG. 1, the storage apparatus 4 is connected via the management terminal 6 to the management computer 7; however, the configuration in which the storage apparatus 4 is directly connected to the LAN may be used. Furthermore, if the physical computer 2 has a function of the management computer 7, the configuration in which the virtual computer system 1 is not equipped with the management computer 7 may be used.

The physical computer 2 is composed of, for example, a personal computer or a workstation and includes a CPU (Central Processing Unit) 10, a memory 11, a plurality of NICs (Network Interface Cards) 12, a plurality of HBAs (Host Bus Adapters) 13, and a storage device 16. The physical computer 2 includes input devices 14 such as a keyboard and a mouse, and output devices such as a display 15.

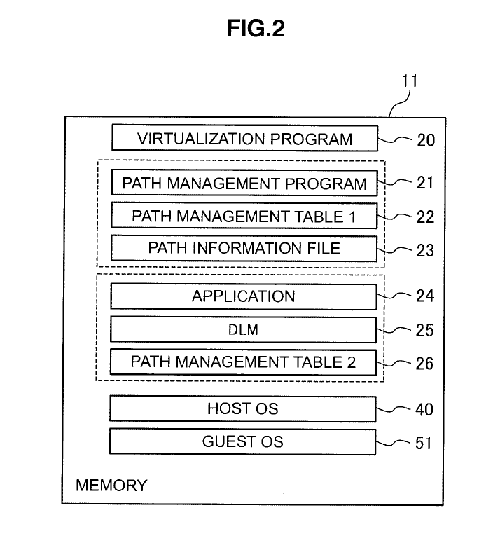

The CPU 10 is a processor for controlling the operation of the entire physical computer 2 and executes necessary processing based on control programs stored in the memory 11. As shown in FIG. 2, the memory 11 is used to store a host OS (Operating System) 40, a guest OS 51, and control programs such as a virtualization program 20 for providing the virtual environment having a plurality of virtual machines (VM), and is also used as a work memory for the CPU 10. A path management program 21, a first path management table 22, a path information file 23, application software 24, a path redundant program (DLM: Device Link Manager) 25, and a second path management table 26, which will be explained later in detail, are also stored and retained in this memory 11.

The NICs 12 are provided in the physical computer 2, the management computer 7, the management terminal 6, and the switch 5, respectively, and are communication interfaces for performing protocol control during communication between these components. Each NIC 12 is assigned one or more network addresses such as an IP (Internet Protocol) address. In this embodiment, the NICs 12 are connected to each other via the LAN 27. The NIC 12 for the physical computer 2 is virtualized and assigned to each virtual machine 50. The host OS 40 and the virtual machines 50 are designed to exchange necessary information and commands via a virtual LAN.

The physical HBAs 13 are communication interfaces for performing protocol control during communication between the physical computer 2 and the storage apparatus 4. Each physical HBA 13 is also assigned one or more network addresses such as a WWN (World Wide Name).

The switch 5 is, for example, a fibre channel switch or a TCP/IP switch. The switch 5 includes HBAs and NICs for connections with the physical computer 2, the management computer 7, and the storage apparatus 4 and establishes a connection between networks. In the following explanation, the network 3 serving also as and including the switch 5 will be described. The network 3 is composed of, for example, a SAN (Storage Area Network), a LAN, the Internet, public circuits, or private circuits. Communication between the physical computer 2 and the storage apparatus 4 via the network 3 is performed, for example, according to Fibre Channel Protocol when the network 3 is a SAN, or according to TCP/IP (Transmission Control Protocol/Internet Protocol) when the network 3 is a LAN.

The storage apparatus 4 is constituted from one or more disk devices 30 and a controller 31 for controlling data input/output to/from the disk devices 30.

The disk devices 30 are composed of expensive disks such as SCSI (Small Computer System Interface) disks or inexpensive disks such as SATA (Serial AT Attachment) disks or optical disks. One or more disk devices 30 constitute one RAID group 32, and one or more logical volumes VOL are set on a physical storage area provided by each of the disk devices 30 constituting one RAID group 32. Data from the physical computer 2 is stored in blocks of specified size in the logical volumes VOL, each block serving as a unit (hereinafter referred to as the “logical block”).

A unique volume number is assigned to each logical volume VOL. In this embodiment, data is input and/or output by specifying the address of the relevant logical block, using a combination of this volume number and a unique number assigned to each logical block (hereinafter referred to as the “LBA [Logical Block Address]”) as the address of the relevant logical block.

The controller 31 includes one or more channel adapters (CHA) 33, a memory 35, a CPU 36, a cache 38, a control memory 34, a port 37, and an NIC 39. When receiving an I/O request from the physical computer 2 via the network 3, the controller 31 reads/writes data from/to the relevant disk device 30 in response to this I/O request.

The channel adapter 33 is an interface for communicating with the physical computer 2 via the network 3. The memory 35 stores necessary control information for processing to be executed by the CPU 36. The CPU 36 specifies an access target device in response to an I/O request received via the channel adapter 33 and processes the I/O request. When doing so, the CPU 36 specifies the access target device, using the LUN (Logical Unit Number) contained in the I/O request. The cache 38 stores data in advance for a read request from the physical computer 2 or temporarily store data received from the physical computer 2. Accordingly, the processing speed for access requests is enhanced. The control memory 34 stores control information about logical volumes and control information about whether data in the cache is reflected on the disks or not.

The management terminal 6 includes a CPU 61, a memory 62, a storage device 66, an NIC 6 connected to the storage apparatus 4, an NIC 64 connected to the LAN 27, an input device 65 for accepting input by a storage administrator, and an output device such as a display 63 for outputting configuration information and management information about the storage apparatus 4 to the storage administrator. The CPU 61 reads storage management programs stored in the storage device 66 to the memory 62 and executes the storage management programs, thereby, for example, referring to the configuration information and giving instructions to change the configuration and perform specific functions; and the CPU 61 serves as an interface between the storage administrator or the management computer 7 and the storage apparatus 4 with regard to maintenance and operation of the storage apparatus 4. Incidentally, this embodiment may use the configuration in which the storage apparatus 4 is connected directly to the management computer 7 without using the management terminal 6 as an intermediary, and the storage apparatus 4 is managed using management software operating on the management computer 7.

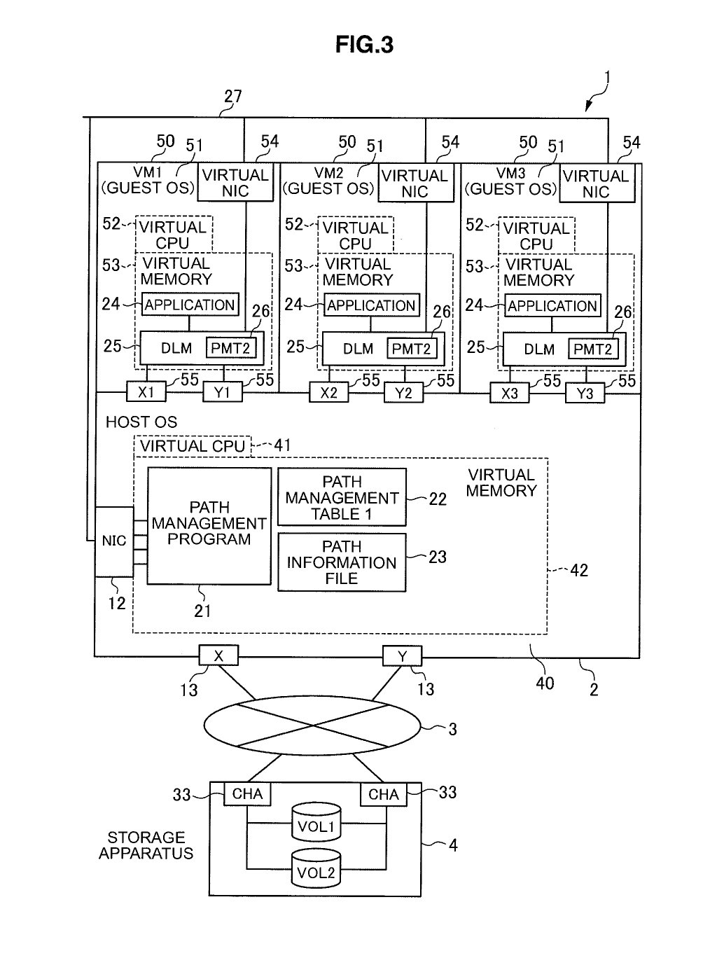

FIG. 3 shows the logical configuration of the virtual computer system 1. For ease of explanation, only the physical computer 2, the network 3, and the storage apparatus 4 are illustrated. The OS (hereinafter referred to as the “host OS”) 40 operates on the physical computer 2. The virtualization program 20 (FIG. 1) operates on this host OS 40. Furthermore, one or more guest OS's 51 operate on this virtualization program 20. The guest OS 51 is an operating system that operates on a virtual machine 50 configured by the virtualization program 20.

On the host OS 40, a virtual CPU 41 (hereinafter referred to as the “virtual CPU”) made by time-sharing the CPU 10 for the physical computer 2 (FIG. 1) and a virtual memory 42 (hereinafter referred to as the “virtual memory”) made by logically dividing the memory 11 for the physical computer 2 (FIG. 1) exist. In the following explanation, storing data in the virtual memory means, in fact, storing data in the memory 11.

On the guest OS 51, a virtual CPU 52, a virtual memory 53, a virtual NIC 54 made by virtualizing the NIC 12 for the physical computer 2 (FIG. 1), and a plurality of virtual HBAs 55 made by virtualizing any of the physical HBAs 13 for the physical computer 2 exist. The virtual CPU 52 is made by time-sharing the CPU 10 for the physical computer 2. The virtual memory 53 is made by logically dividing the memory 11 for the physical computer 2. One virtual machine (VM: Virtual Machine) 50 is constituted from one guest OS 51, and the virtual CPU 52, virtual memory 53, virtual NIC 54, and virtual HBAs 55 which exist on the guest OS 51.

The virtual memory 42 on the host OS 40 stores the path management program 21, the first path management table (PMT) 22, and the path information file 23. The virtual memory 53 for each virtual machine 50 stores the application software 24 and the path redundant program (DLM: Device Link Manager) 25 for managing the second path management table (PMT) 26.

The path management program 21 is a program for managing paths connected to the virtual machines 50, respectively, which are defined on the physical computer 2, and is resident on the host OS 40. The virtual CPU 41 for the host OS 40 creates and updates, for example, the first path management table 22 and the path information file 23 based on this path management program 21.

Referring to FIG. 3, “X” and “Y” for the physical HBA 13 represent the IDs of the physical HBAs 13. Also, “X1” to “X3” and “Y1” to “Y3” for the virtual HBAs 55 represent the IDs of the virtual HBAs 55. FIG. 3 shows that the physical HBA 13 with the ID “X” is virtualized so that the virtual HBAs 55 with the IDs “X1” to “X3” are assigned to the virtual machines 50, respectively. The same can be said for the physical HBA 13 with the ID “Y.” Processing for allocating the physical HBA 13 to the virtual machines 50 is executed by the CPU 10.

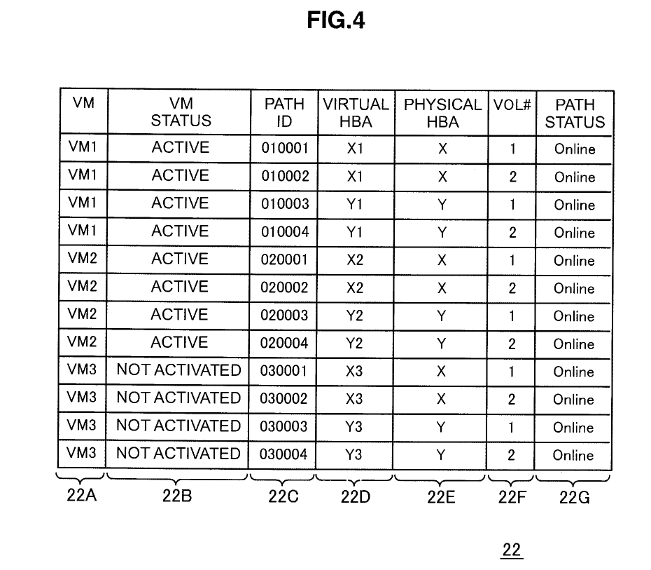

The first path management table 22 is a table used by the path management program 21 to consolidate the management of the path status of each virtual machine 50 defined on the physical computer 2, and is constituted from a “VM” field 22A, a “VM status” field 22B, a “path ID” field 22C, a “virtual HBA” field 22D, a “physical HBA” field 22E, a “volume number” field 22F, and a “path status” field 22G as shown in FIG. 4.

The “VM” field 22A stores the machine ID of the relevant virtual machine 50 from among the virtual machines 50 defined on the physical computer 2; and the “VM status” field 22B stores the status (“active,” “not activated,” or “inactive”) of that virtual machine 50.

The “virtual HBA” field 22D stores the ID of a virtual HBA 55 (FIG. 3) belonging to that virtual machine 50, and the “physical HBA” field 22E stores the ID of a physical HBA 13 (FIG. 1) which is virtualized to the virtual HBA 55. Furthermore, the “volume number” field 22F stores the volume number of a logical volume VOL in the storage apparatus 4, which is associated with the virtual HBA 55 in the same row (entry).

Furthermore, the “path ID” field 22C stores the path ID of a path connecting the relevant virtual HBA 55 to the logical volume VOL associated with that virtual HBA 55, and the “path status” field 22G stores the current status of that path. Incidentally, there are two types of the path status: “online” representing the available state and “offline” representing the blocked state.

Therefore, FIG. 4 shows a case where, for example, a virtual machine 50 with the ID “VM1” which is currently “active” has a virtual HBA 55 with the ID “X1” created by virtualizing a physical HBA 13 with the ID “X”; and this virtual HBA 55 is connected to a logical volume with the volume number “1” in the storage apparatus 4 via a path with the path ID “010001” and that path is in the “online” state.

The path information file 23 is a file that stores the content of the first path management table 22. The path management program 21 outputs the content of the first path management table 22 to the path information file 23 at the time of termination of the program execution, and creates the first path management table 22 based on this path information file 23 at the time of activation of the path management program.

Meanwhile, the path redundant program 25 is a program for managing each path connected to the virtual machine 50 on the virtual machine 50 side. This path redundant program 25 has: a function detecting a failure in the relevant path (path failure) based on the transmission result of an I/O request issued via the virtual HBA 55; a function blocking the relevant path (making it offline) when the path failure is detected; a function notifying the path management program 21 of the path failure when it is detected; and a function making the relevant path available (making it online) when recovery of the blocked path is confirmed.

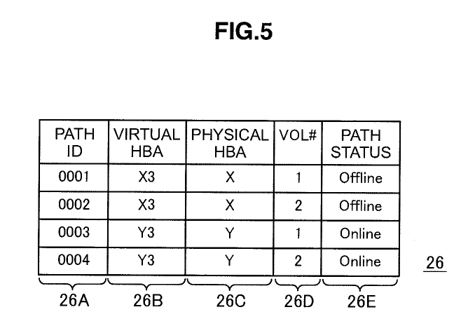

The second path management table 26 is a table used by the path redundant program 25 to manage each path defined for the corresponding virtual machine 50 and is constituted from a “path ID” field 26A, a “virtual HBA” field 26B, a “physical HBA” field 26C, a “volume number” field 26D, and a “path status” field 26E as shown in FIG. 5. The “path ID” field 26A stores a unique path ID assigned by the virtual machine 50 to the relevant path. The “virtual HBA” field 26B, the “physical HBA” field 26C, the “volume number” field 26D, and the “path status” field 26E store the same information stored in the “virtual HBA” field 22D, the “physical HBA” field 22E, the “volume number” field 22F, and the “path status” field 22G for the corresponding entry in the first path management table 22, respectively.

### (2) Path Management Function according to This Embodiment

Next, a path management function of the physical computer 2 according to this embodiment will be explained. Incidentally, the following explanation may be given assuming that agents executing various kinds of processing are “programs” or “software”; however, needless to say, the host OS 40 or the virtual CPU 41, 52 for the virtual machine 50 (more precisely, the CPU 10 for the physical computer 2) actually executes the processing based on the programs or software.

In this embodiment, the physical computer 2 is equipped with a first path management function and a second path management function. If any virtual machine 50 detects a path failure, the first path management function blocks paths (makes the paths offline) routed through the same physical HBA 13 through which the path where the failure has been detected (hereinafter referred to as the “faulty path”) is routed, in that virtual machine 50 and other virtual machines 50. If any virtual machine 50 detects recovery of the faulty path, the second path management function makes paths, which are routed through the same physical HBA 13 through which the path where the recovery has been detected (hereinafter referred to as the “recovered path”) is routed, return to the online state in that virtual machine 50 and other the virtual machines 50.

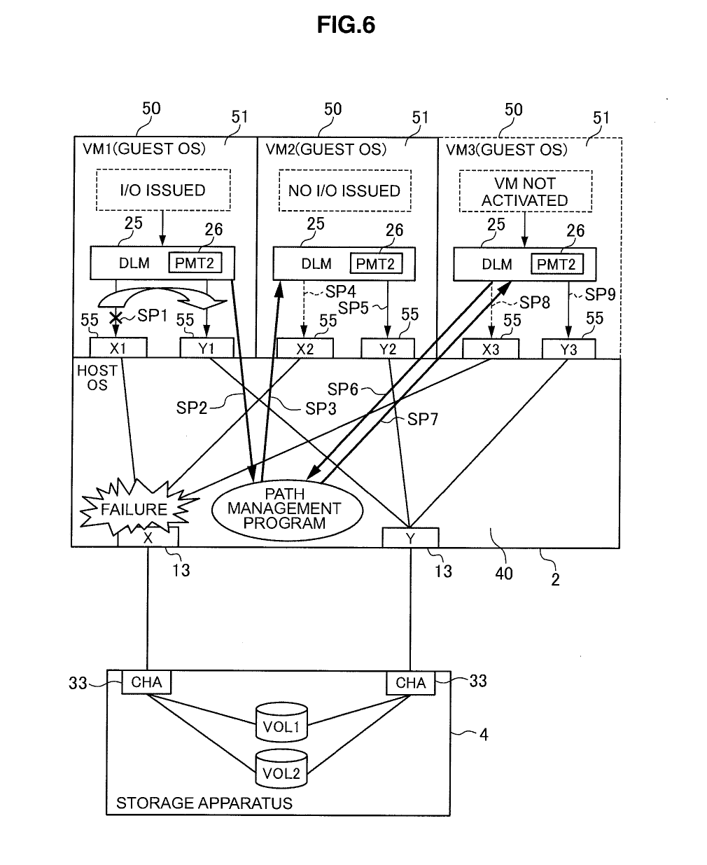

The first path management function from among the path management functions described above according to this embodiment will be specifically explained below with reference to FIGS. 4 and 6.

For example, assuming that the system was at first in the condition shown in FIGS. 1 and 4 and then a failure has occurred in the physical HBA 13 with the ID “X” as shown in FIG. 6, even if the application software for the virtual machine 50 with the machine ID “VM1” sends an I/O request via the virtual HBA 55 with the ID “X1” to the storage apparatus 4, that virtual machine 50 cannot receive a response for the I/O request from the storage apparatus 4 and will eventually receive an error notice or a time-out will occur.

When this happens, the path redundant program 25 for the virtual machine 50 determines that a path failure has occurred in a path connected to the relevant virtual HBA 55; and the path redundant program 25 executes block processing for blocking that path (SP1). The path redundant program 25 also notifies the path management program 21 for the host OS 40 of specified path failure information (SP2). Therefore, if a path failure is detected in a path with the ID “010001” in an example shown in FIGS. 4 and 6, the path redundant program 25 for the virtual machine 50 with the ID “VM1” blocks this path and notifies the path management program 21 of the path failure information indicating that the failure has occurred in this path.

Meanwhile, after receiving the path failure information, the path management program 21 searches the first path management table 22 for the virtual machines 50 connected to other paths routed through the physical HBA 13 through which the faulty path is routed as notified by the path failure information. Once the path management program 21 detects such virtual machines 50, it gives an instruction (hereinafter referred to as the “path block instruction”) to the path redundant program 25 for the virtual machines 50 to block such “other” paths (SP3). In the case of the example shown in FIGS. 4 and 6, the path management program 21 gives the path block instruction to the virtual machine 50 with the ID “VM1” to block the path with the ID “010002,” gives the path block instruction to the virtual machine 50 with the ID “VM2” to block two paths with the IDs “020001” and “020002,” and gives the path block instruction to the virtual machine 50 with the ID “VM3” to block two paths with the IDs “030001” and “030002.”

After receiving this path block instruction, the path redundant program 25 for the virtual machine 50 with the ID “VM3” executes block processing for blocking the paths designated by the path block instruction (SP4), and thereafter communication with the storage apparatus 4 will be performed via paths other than the blocked paths (SP5). In the example shown in FIGS. 4 and 6, the path redundant program 25 for the virtual machine 50 with the ID “VM2” blocks the two paths “020001” and “020002”, and thereafter communication with the storage apparatus 4 will be performed via the path “020003” or “020004.”

When in the example shown in FIGS. 4 and 6 the path management program 21 sends the path block instruction to the virtual machine 50 with the ID “VM3,” if the status of the relevant virtual machine 50 is “not activated,” this virtual machine 50 cannot follow the path block instruction. As a result, the paths designated by the path block instruction (the two paths “030001” and “030002”) will not be blocked.

Therefore, in this embodiment, the path redundant program 25 for the virtual machine 50 inquires of the path management program 21 about whether there is a path failure or not, at the time of activation of the relevant virtual machine 50 (SP6). In response to the inquiry, the path management program 21 notifies the relevant path redundant program 25 of the physical HBA 13 where a failure has occurred, and the path failure information about the paths which can be used by the relevant virtual machine 50 (SP7).

After receiving the path failure information, the path redundant program 25 executes the block processing for blocking the paths routed through the physical HBA 13 where the failure has occurred, from among the paths connected to its own virtual machine 50 (SP8), and thereafter communication with the storage apparatus 4 will be performed using the paths other than the blocked paths (SP9). For example, in the aforementioned case, the virtual machine 50 with the ID “VM3” blocks the two paths “030001” and “030002” based on the path failure information from the path management program 21, and thereafter communication with the storage apparatus 4 will be performed using the paths “030003” and “030004.”

The above-described processing makes it possible to prevent the virtual machine 50 from using a path routed through the physical HBA 13 where a failure has occurred. Accordingly, it is possible to effectively prevent an I/O delay caused by the occurrence of a time-out.

### (3) Various Kinds of Processing regarding Path Management Function according to This Embodiment

Next, specific details of processing executed by the path management program 21 on the host OS 40 and the guest OS 51 for the virtual machine 50 regarding the path management functions described above according to this embodiment will be explained below.

(3-1) Path Management Program Activation Processing

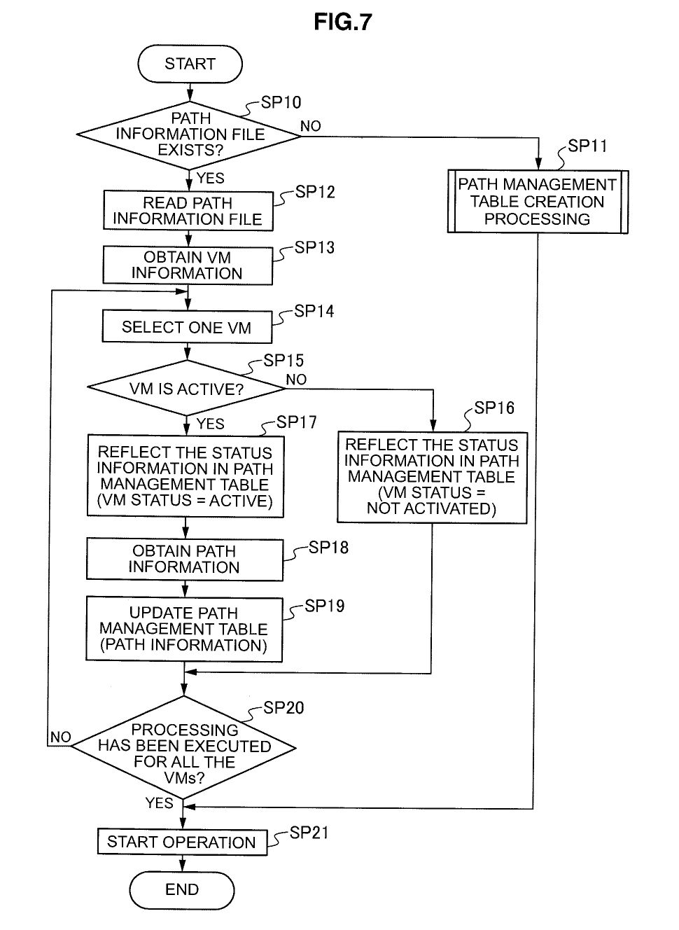

FIG. 7 shows a processing sequence for path management program activation processing executed by the path management program 21 on the host OS 40. The path management program 21 creates the first path management table 22 in accordance with the processing sequence shown in FIG. 7 during the activation processing.

After being activated according to the user's instruction or by the host OS 40 during the activation processing, the path management program 21 starts this path management program activation processing, first searches the virtual memory 42 on the host OS 40, and judges whether the path information file 23 exists or not (SP10).

If SP10 returns a negative judgment (SP10: NO), the path management program 21 creates a new first path management table 22 (which was described earlier with reference to FIG. 4) (SP11), and then proceeds to SP21.

On the other hand, if SP10 returns an affirmative judgment (SP10: YES), the path management program 21 reads the path information file 23 from the virtual memory 42 and creates the first path management table 22 based on the read path information file 23 (SP12).

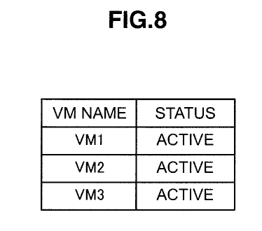

Next, the path management program 21 obtains the VM information which is definition information about the virtual environment (SP13). This VM information is information that associates the machine ID of each virtual machine 50 defined on the physical computer 2, with the current status of that virtual machine 50 as show in FIG. 8, and the VM information is created by the user in advance and stored in the memory 11 for the physical computer 2 (FIG. 1).

Subsequently, the path management program 21 selects one virtual machine 50 whose machine ID is registered in the VM information obtained in SP13 (SP14); and then judges, based on the VM information, whether the virtual machine 50 is “active” or not (SP15).

If SP15 returns a negative judgment (SP15: NO), the path management program 21 stores “not activated” as the status of the virtual machine 50 in the “VM status” field 22B (FIG. 4) for the entry corresponding to that virtual machine 50 in the first path management table 22 created in SP12 (SP16), and then proceeds to SP20.

On the other hand, if SP15 returns an affirmative judgment (SP15: YES), the path management program 21 stores “active” as the status of the virtual machine 50 in the “VM status” field 22B (FIG. 4) for the entry corresponding to that virtual machine 50 in the first path management table 22 created in SP12 (SP17).

Subsequently, the path management program 21 inquires of the path redundant program 25 for the virtual machine 50 (FIG. 3) about information about each path connected to that virtual machine 50. In response to this inquiry, the path redundant program 25 notifies the path management program 21 of the path IDs of paths, each of which is registered in the second path management table 26 (FIG. 3), the IDs of the virtual HBAs 55 (FIG. 3) connected to these paths respectively, and the volume numbers of the logical volumes VOL connected to these paths respectively, as the path information (SP18). The path management program 21 makes the thus obtained path information reflected in the first path management table 22 (SP19).

Incidentally, each virtual machine 50 manages the paths connected to its own virtual machine by assigning a unique path ID to each path as described later. So, if the path information collected from each virtual machine 50 is reflected in the first path management table 22, there is a possibility that there might be redundant path IDs. Therefore, when the path management program 21 makes the path information, which was collected from the virtual machines 50, reflected in the first path management table 22, it creates a new path ID by adding the ID of the relevant virtual machine 50 to the top of the path ID of each path obtained in SP18 and registers this new path ID, as the path ID of that path, in the first path management table 22. Accordingly, regarding the path with the path ID, for example, “0001” regarding which the path information has been collected from the virtual machine 50 with the machine ID “01,” a new path ID “010001” created by adding “01” to the top of “0001” is registered for that path in the first path management table 22.

Next, the path management program 21 judges, based on the VM information obtained in SP13, whether or not the processing from SP14 to SP19 has been executed for all the virtual machines 50 defined on the physical computer 2 (SP20).

If SP20 returns a negative judgment (SP20: NO), the path management program 21 returns to SP14 and then sequentially switches the virtual machine 50 selected in SP14 from one virtual machine 50 to another and repeats the processing from SP14 to SP20.

If SP20 returns an affirmative judgment (SP20: YES) by eventually finishing executing the processing from SP14 to SP20 for all the virtual machines 50 defined on the physical computer 2 (SP20: YES), the path management program 21 completes the activation processing and starts monitoring the status of each path which is set for each virtual machine 50 (SP21); and then, the path management program 21 terminates this path management program activation processing.

(3-2) Path Management Table Creation Processing

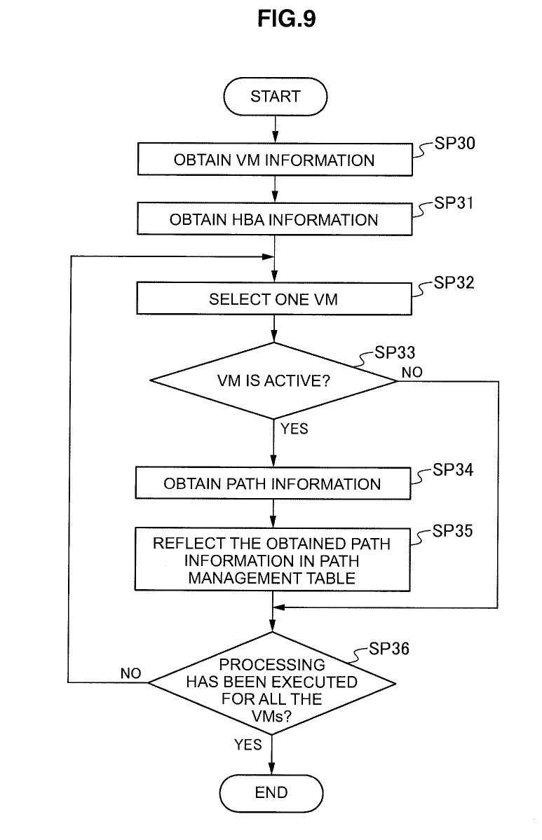

FIG. 9 shows a processing sequence for path management table creation processing executed by the path management program 21 in SP11 of the path management program activation processing (FIG. 7). The path management program 21 creates a new first path management table 22 in accordance with the processing sequence shown in FIG. 9.

Specifically speaking, when the path management program 21 proceeds to SP11 of the path management program activation processing, it starts this path management table creation processing and first obtains the VM information in the same manner as in SP13 of the path management program activation processing (SP30).

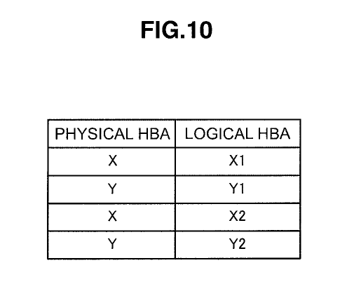

Next, the path management program 21 obtains HBA information which is definition information about resource allocation to each virtual machine 50 (SP31). This HBA information is, as shown in FIG. 10, information indicating the correspondence relationship between HBAs recognized by the virtual machines 50 and HBAs recognized by the host OS 40, and is created by the user in advance and stored in the memory 11 for the physical computer 2 (FIG. 1).

Subsequently, the path management program 21 selects one virtual machine 50 whose machine ID is registered in the VM information obtained in SP30 (SP32); and then judges whether the status of the virtual machine 50 is “active” or not (SP33).

If SP33 returns a negative judgment (SP33: NO), the path management program 21 proceeds to SP36. On the other hand, if SP33 returns an affirmative judgment (SP30: YES), the path management program 21 obtains the path information about the relevant virtual machine 50 in the same manner as in SP18 of the path management program activation processing (SP34), and then makes the obtained path information reflected in the first path management table 22 (SP35).

Next, the path management program 21 judges, based on the VM information obtained in SP30, whether or not the processing from SP32 to SP35 has been executed for all the virtual machines 50 defined on the physical computer 2 (SP36).

If SP36 returns a negative judgment (SP36: NO), the path management program 21 returns to SP32 and then sequentially switches the virtual machine 50 selected in SP32 from one virtual machine 50 to another and repeats the processing from SP32 to SP36.

If SP36 returns an affirmative judgment (SP36: YES) by eventually finishing executing the processing from SP32 to SP35 for all the virtual machines 50 defined on the physical computer 2 (SP36: YES), the path management program 21 completes the path management table creation processing and then returns to the path management program activation processing (FIG. 7).

(3-3) Guest OS Activation Processing

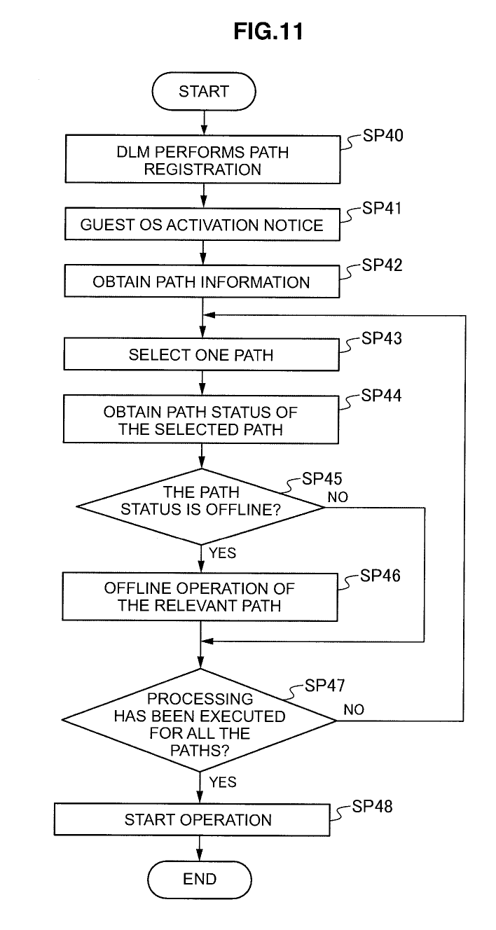

FIG. 11 shows a processing sequence for guest OS activation processing executed by the guest OS 51 for the virtual machine 50 (FIG. 3). After being activated by the virtualization program 20 (FIG. 1), the guest OS 51 starts this guest OS activation processing, first activates the path redundant program 25 (FIG. 3) and has it create the second path management table 26 (FIG. 3) (SP40).

Specifically speaking, during the activation processing, the path redundant program 25 issues, for example, an INQUIRY command according to SCSI (Small Computer System Interface) Protocol to all the virtual HBAs 55 (FIG. 3) existing on that guest OS 51, thereby collecting the volume numbers of the logical volumes VOL in the storage apparatus 4, which are connected via paths to the virtual HBAs 55, respectively. Then, based on the information thus collected and the aforementioned VM information and HBA information stored in the memory 11 for the physical computer 2, the path redundant program 25 creates the second path management table 26. Incidentally, when doing so, the path redundant program 25 assigns a unique path ID (for example, a sequential number) to each path and stores this path ID in the relevant “path ID” field 26A (FIG. 5) in the second path management table 26. Also, the path redundant program 25 stores “online” as the path status of the relevant path in the “path status” field 26E (FIG. 5) for each entry in the second path management table 26.

Next, the guest OS 51 notifies the path management program 21 on the host OS 40 that the guest OS 51 itself has been activated (SP41). Specifically speaking, the guest OS 51 sends information comprised of the machine ID of the relevant virtual machine 50 and the status (“active”) of that virtual machine 50 (hereinafter referred as the “the activation notice information”) to the path management program 21 in accordance with an OS activation script. If the guest OS 51 for the virtual machine 50 with the ID “VM3” is activated, the guest OS 51 sends the activation notice information, which stores information such as “VM3” as “the machine ID” and “active” as the status of the virtual machine 50, to the path management program 21.

Incidentally, after receiving the activation notice information, the path management program 21 updates the first path management table 22 based on this activation notice information. Specifically speaking, if the path management program 21 receives the activation notice information from the guest OS 51 for the virtual machine 50 with the ID “VM3,” it changes the status of the relevant virtual machine 50 in the “VM status” field 22B (FIG. 4) from “not activated” to “active” for all the entries corresponding to the virtual machine 50 with the ID “VM3” in the first path management table 22.

Subsequently, the guest OS 51 obtains path information about all the paths connected to the virtual machine 50 configured by the guest OS 51 itself, by inquiring of the path management program 21 for the host OS 40 (SP42). For example, in the case of the guest OS 51 for the virtual machine 50 with the ID “VM3,” the guest OS 51 obtains, as the path information, information about all the entries in which “VM3” is stored in the “VM” field 22A (FIG. 4) in the first path management table 22, by making such an inquiry (see FIGS. 4 and 5).

Next, the guest OS 51 selects one path whose path ID is contained in the path information obtained in SP42 (SP43). The guest OS 51 reads the path status of that path from the path information obtained in SP42 (SP44), and then judges whether the path status of the path is “offline” or not (SP45).

If SP45 returns a negative judgment (SP45: NO), the guest OS 51 proceeds to SP47. On the other hand, if SP45 returns an affirmative judgment (SP45: YES), the guest OS 51 blocks the path by changing the path status stored in the “path status” field 26E (FIG. 5) for the entry corresponding to that path in the second path management table 26, from “online” to “offline” (SP46).

Next, the guest OS 51 judges, based on the path information obtained in SP42, whether or not the processing from SP43 to SP46 has been executed for all the paths connected to the virtual machine 50 configured by the relevant guest OS 51 (SP47).

If SP47 returns a negative judgment (SP47: NO), the guest OS 51 returns to SP43 and then sequentially switches the path selected in SP43 from one path to another and repeats the processing from SP43 to SP47.

If SP47 returns an affirmative judgment (SP47: YES) by eventually finishing executing the processing from SP43 to SP46 for all the paths connected to the virtual machine 50 configured by the guest OS 51 itself, the guest OS 51 completes its own activation processing and starts normal processing (SP48). Subsequently, the guest OS 51 terminates this guest OS activation processing.

As a result of the guest OS activation processing described above, the path routed through the physical HBA 13 (FIG. 1) where a failure has occurred, from among the paths connected to the virtual machine 50 configured by the guest OS 51 which executes this guest OS activation processing, is already blocked when the activation of the relevant guest OS 51 is finished. Therefore, an I/O delay caused by the path failure can be effectively prevented immediately after starting the operation of the relevant virtual machine 50.

(3-4) Path Failure Dealing Processing

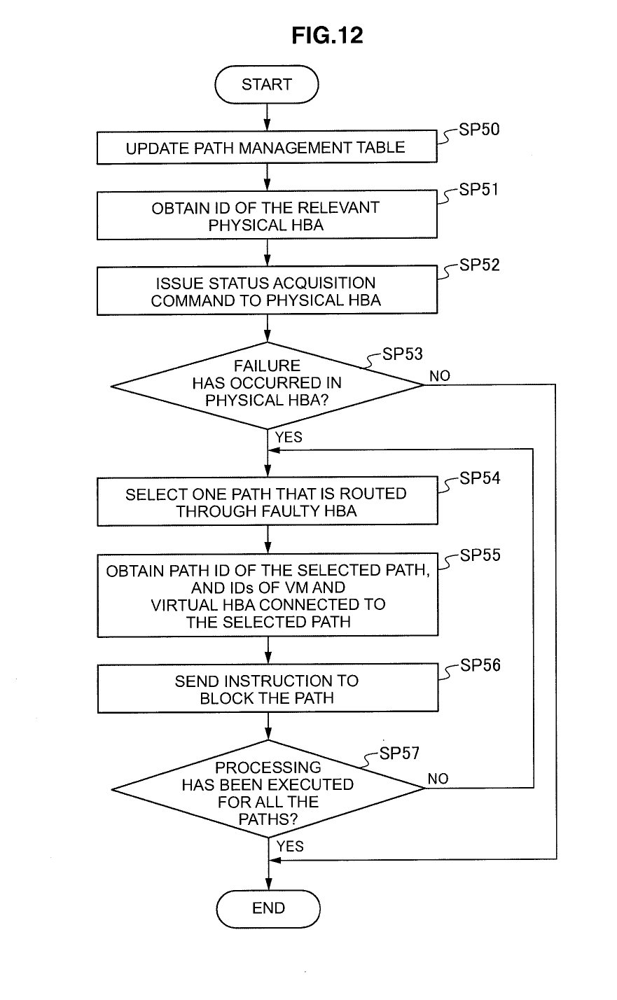

FIG. 12 shows a processing sequence for path failure dealing processing executed by the path management program 21 for the host OS 40.

When the path redundant program 25 for each virtual machine 50 detects a failure in a path connected to its own virtual machine 50, it sends the corresponding path failure information via the virtual LAN 27 (FIG. 3) to the host OS 40, using, for example, TRAP according to SNMP (Simple Network Management Protocol). After receiving this path failure information, the path management program 21 for the host OS 40 executes processing for the path failure in accordance with the processing sequence shown in FIG. 12.

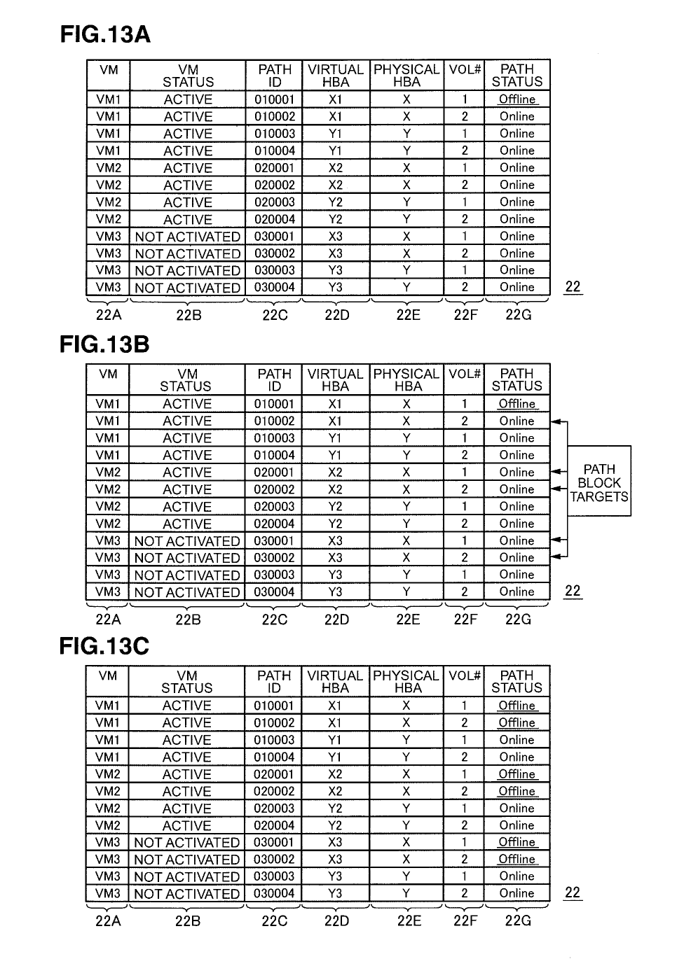

Specifically speaking, after receiving the path failure information, the path management program 21 starts the path failure dealing processing and first updates the “path status” field 22G (FIG. 4) for the entry corresponding to the path, in which the failure has occurred, in the first path management table 22 based on the received path failure information (SP50). For example, if in the condition shown in FIG. 4 the path management program 21 receives the path failure information indicating that a failure has occurred in the path “010001,” from the path redundant program 25 for the virtual machine 50 with the ID “VM1,” the path management program 21 changes the path status stored in the “path status” field 22G for the entry corresponding to the path “010001” connected to the virtual machine 50 with the ID “VM1” in the first path management table 22 from “online” to “offline” as shown in FIG. 13A.

Next, the path management program 21 searches the first path management table 22 for the physical HBA 13 for the physical computer 2(FIG. 1), through which the path where the failure has occurred is routed (SP51); and the path management program 21 sends a status acquisition command, which is a command to obtain the status, to the physical HBA 13 detected by the above search (SP52).

Based on a response from the physical HBA 13 to the status acquisition command, the path management program 21 judges whether a failure has occurred in the physical HBA 13 or not (SP53). If the response from the physical HBA 13 is an error (in the case where the status of the physical HBA 13 is not “ready” or “online”), the path management program 21 determines that a failure has occurred in that physical HBA 13; and if the response is not an error, the path management program 21 determines that a failure has not occurred in that physical HBA 13.

If SP53 returns a negative judgment (SP53: NO), it can be assumed that a failure has occurred in a device other than the physical HBA 13, for example, a failure in a logical volume VOL or the switch in the path. Therefore, the path management program 21 terminates this path failure dealing processing without blocking any path.

On the other hand, if SP53 returns an affirmative judgment (SP53: YES), the path management program 21 refers to the first path management table 22 and selects one path from among paths routed through the physical HBA 13 where the failure has occurred (SP54); and then obtains the path ID of that path as well as the machine ID of the virtual machine 50 connected to the path and the ID of the virtual HBA 55 (FIG. 3) connected to the path on that virtual machine 50, from the first path management table 22 (SP55).

The path management program 21 changes the path status stored in the “path status” field 22G (FIG. 4) for the corresponding entry in the first path management table 22 from “online” to “offline”; and based on the path ID and the machine ID obtained in SP55, the path management program 21 sends the path block instruction to the virtual machine 50 with that machine ID to block the path with that path ID, using, for example, TRAP according to SNMP protocol (SP56). After receiving this path block instruction, the path redundant program 25 for the virtual machine 50 executes block processing (processing for changing the “path status” 26E (FIG. 5) for the corresponding entry in the second path management table 26 to “offline”) for blocking the path with the path ID designated by the path block instruction.

Subsequently, the path management program 21 refers to the first path management table 22 and judges whether or not the processing from SP54 to SP56 has been executed for all the paths routed through the physical HBA 13 where the failure has occurred (SP57).

If SP 57 returns a negative judgment (SP57: NO), the path management program 21 returns to SP54 and then sequentially select another path in SP57 and repeats the processing from SP54 to SP57. As a result, in the case of FIG. 13A, the processing from SP54 to SP57 will be executed for each of the paths “010002,” “020001,” “020002,” “030001,” and “030002” as shown in FIG. 13B.

However, if the virtual machines 50 with the IDs “VM1” and “VM2” are “active” and the virtual machine 50 with the ID “VM3” is “not activated” as shown in FIG. 13A, the block processing for the relevant paths is executed for only the virtual machines 50 with the IDs “VM1” and “VM2” and is not executed for the virtual machine 50 with the ID “VM3.” Regarding the virtual machine 50 with the ID “VM3,” the block processing for the relevant paths will be executed during the activation processing as explained about the guest OS activation processing (FIG. 11).

If SP57 returns an affirmative judgment (SP57: YES) by eventually finishing blocking all the paths routed through the physical HBA 13 where the failure has occurred as shown in FIG. 13C, the path management program 21 terminates this path failure dealing processing.

(3-5) Path Recovery Processing

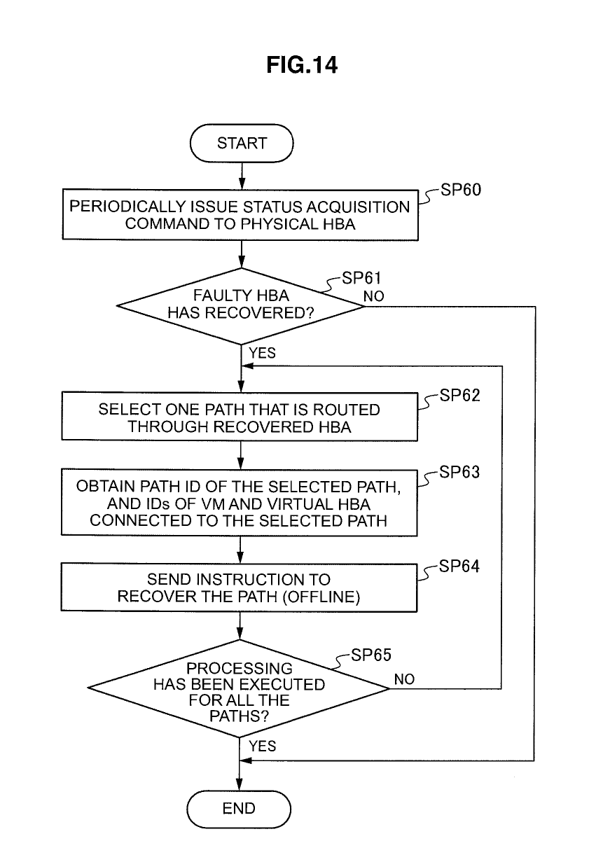

FIG. 14 shows a processing sequence for path recovery processing executed by the path management program 21 for the host OS 40.

The path management program 21 periodically issues an status acquisition command to the physical HBA 13 where a failure has occurred, in order to perform a health check (SP60).

Based on a response from the physical HBA 13 to the status acquisition command, the path management program 21 judges whether the physical HBA 13 has recovered or not, by the same processing as in SP53 of the path failure dealing processing described with reference to FIG. 12 (SP61).

If SP61 returns a negative judgment (SP61: NO), the path management program 21 terminates this path recovery processing without executing the processing for recovering any path. On the other hand, if SP61 returns an affirmative judgment (SP61: YES), the path management program 21 refers to the first path management table 22 and selects one path from among paths routed through the recovered physical HBA 13 (SP62), and obtains the path ID of that path as well as the machine ID of the virtual machine 50 connected to the path and the ID of the virtual HBA 55 (FIG. 3) connected to the path on that virtual machine 50, from the first path management table 22 (SP63).

The path management program 21 then changes the path status stored in the “path status” field 22G (FIG. 4) for the corresponding entry in the first path management table 22 from “offline” to “online”; and based on the path ID and the machine ID obtained in SP65, the path management program 21 sends a path recovery instruction to the virtual machine 50 with that machine ID to recover the path with that path ID, using, for example, TRAP according SNMP protocol (SP64). After receiving this path recovery instruction, the path redundant program 25 for the virtual machine 50 executes recovery processing (processing for changing the path status for the corresponding entry in the second path management table 26 to “online”) for recovering the path with the path ID designated by the path recovery instruction.

Subsequently, the path management program 21 refers to the first path management table 22 and judges whether or not the processing from SP64 to SP66 has been executed for all the paths routed through the physical HBA 13 which has recovered from the failure (SP65).

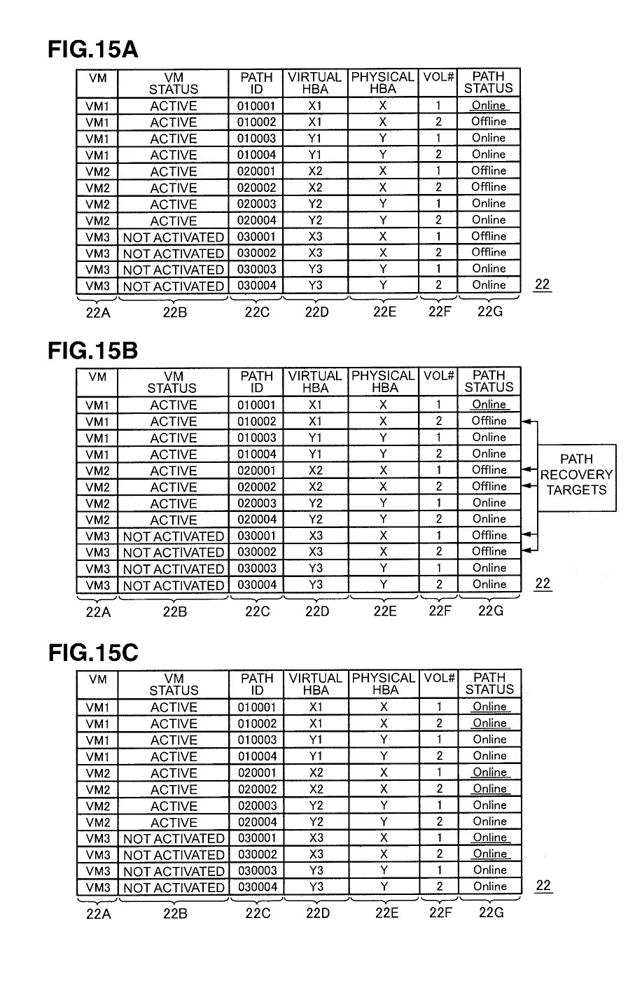

If SP 65 returns a negative judgment (SP65: NO), the path management program 21 returns to SP62 and then sequentially select another path in SP62 and repeats the processing from SP62 to SP65. As a result, in the case of FIG. 15A, the processing from SP64 to SP66 will be executed for each of the paths “010002,” “020001,” “020002,” “030001,” and “030002” as shown in FIG. 15B.

However, if the virtual machines 50 with the IDs “VM1” and “VM2” are “active” and the virtual machine 50 with the ID “VM3” is “not activated” as shown in FIG. 15A, the recovery processing for the relevant paths is executed for only the virtual machines 50 with the IDs “VM1” and “VM2” and is not executed for the virtual machine 50 with the ID “VM3.” Regarding the virtual machine 50 with the ID “VM3,” the recovery processing for the relevant paths will be executed during the activation processing as explained about the guest OS activation processing (FIG. 11).

If SP67 returns an affirmative judgment (SP65: YES) by eventually finishing recovering all the paths routed through the physical HBA 13 which has recovered from the failure as shown in FIG. 15C, the path management program 21 terminates this path recovery dealing processing.

Next, processing to be executed when a failure occurs in a physical HBA while the relevant virtual machine 50 is inactive will be explained. If a failure occurs during hibernation, processing interrupted during the hibernation may possibly issue an I/O request to the physical HBA where the failure has occurred, when resuming the processing. The relevant processing will be explained in sections (3-6) to (3-9).

(3-6) Virtual Machine Hibernation Processing

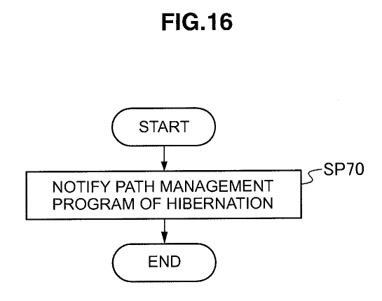

FIG. 16 is a processing sequence for virtual machine hibernation processing executed by the guest OS 51 for the virtual machine 50.

The virtual machine 50 can write memory images and the content of registers to disks and make the processing by the virtual machine inactive (hibernation). When hibernation of the virtual machine 50 is performed, the guest OS 51 notifies the path management program 21 of the execution of hibernation (SP70). Specifically speaking, the guest OS 51 sends information comprised of the machine ID of the relevant virtual machine 50 and the status (“inactive”) of that virtual machine 50 (hereinafter referred to as the “inactive status notice information”) to the path management program 21. If the guest OS 51 for the virtual machine 50 with the ID “VM1” is made inactive, the guest OS 51 sends the inactive status notice information which stores information comprised of “VM1” as “the machine ID” and “inactive” as the status of the virtual machine 50, to the path management program 21.

After receiving the inactive status notice information, the path management program 21 updates the first path management table 22 based on this inactive status notice information. Specifically speaking, if the path management program 21 receives the inactive status notice information from the guest OS 51 for the virtual machine 50 with the ID “VM1,” it changes the status of the relevant virtual machine 50 stored in the “VM status” field 22B for all the entries corresponding to the virtual machine 50 with the ID “VM1” in the first path management table 22 from “active” to “inactive.”

(3-7) Path Failure Dealing Processing during Hibernation

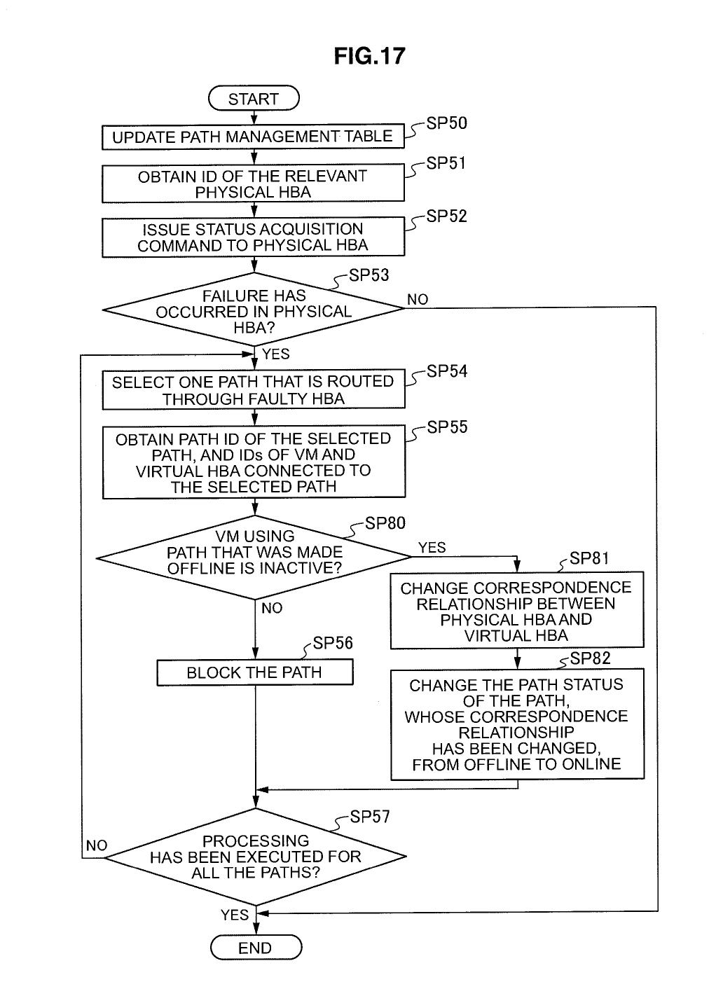

FIG. 17 shows a processing sequence for processing executed by the path management program 21 for the host OS 40. The difference between the processing sequence shown in FIG. 12 and that in FIG. 17 is from SP80 to SP82. The difference from the processing described in section (3-4) will be mainly explained below.

Since the processing from SP50 to SP55 is the same as that described in section (3-4) regarding the path failure dealing processing, an explanation thereof has been omitted.

If there is any entry whose “VM status” field 22B stores “inactive” and “path status” field 22G stores “offline” in the first path management table 22 (SP80: YES), the path management program 21 proceeds to SP81. For example, if a failure occurs in the physical HBA “X,” the path management program 21 changes the correspondence relationship between the virtual HBA “X1” for VM1 and HBA “X” in the first path management table 22 to the correspondence relationship between the virtual HBA “X1” and HBA “Y” (SP81). Then, the CPU 10 changes allocation of the physical HBA 13 and the virtual HBA 55.

Subsequently, the path management program 21 changes the “path status” field 22G for the entry, whose correspondence relationship between the virtual HBA and the physical HBA has been changed, from “offline” to “online” (SP82).

Next, the path management program 21 refers to the first path management table 22 and judges whether or not the execution of the processing from SP54 to SP82 has finished for all the paths routed through the physical HBA 13 where the failure has occurred (SP57).

(3-8) Virtual Machine Resume Processing

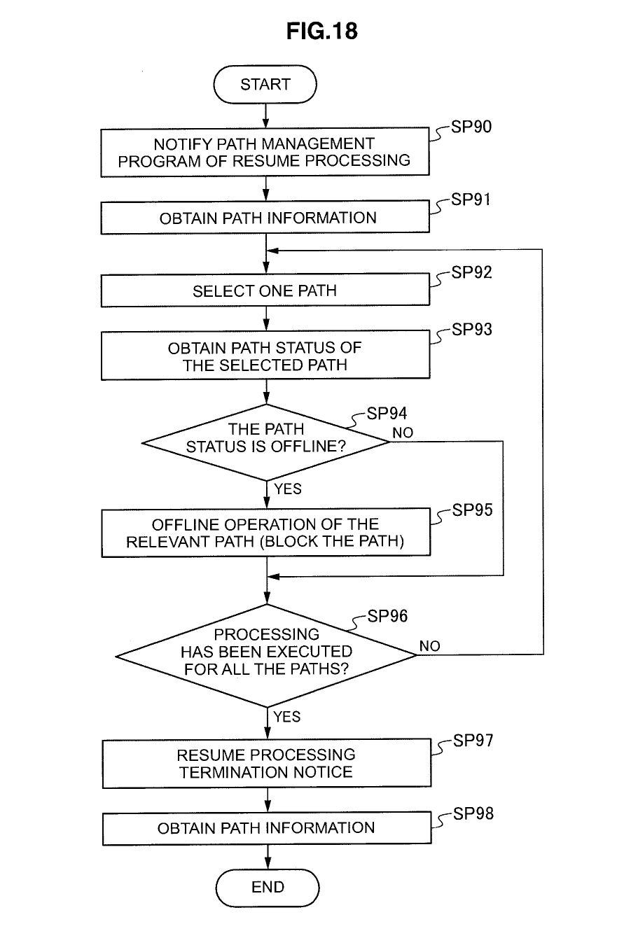

FIG. 18 shows a processing sequence for virtual machine resume processing executed by the guest OS 51 for the virtual machine 50. “Resume” means processing for reactivating the virtual machine 50 which has been inactive because of hibernation.

When the processing for resuming the virtual machine 50 is to be executed, the guest OS 51 notifies the path management program 21 on the host OS 40 of resuming the virtual machine 50 (SP90). Specifically speaking, the guest OS 51 sends information comprised of the machine ID of the relevant virtual machine 50 and the status (“active”) of that virtual machine 50, to the path management program 21. If the guest OS 51 for the virtual machine 50 with the ID “VM1” is to be resumed, the guest OS 51 sends activation notice information, which stores information comprised of “VM1” as “the machine ID” and “active” as the status of the virtual machine 50, to the path management program 21.

After receiving the activation notice information, the path management program 21 updates the first path management table 22 based on this activation notice information. Specifically speaking, if the path management program 21 receives the activation notice information from the guest OS 51 for the virtual machine 50 with the ID “VM1,” it changes the status of the relevant virtual machine 50 stored in the “VM status” field 22B for all the entries corresponding to the virtual machine 50 with the ID “VM1” in the first path management table 22 from “inactive” to “active.” Then, the path management program 21 changes the “path status” field 22G of the paths, whose VM status has been changed, from “online” to “offline.”

Subsequently, the guest OS 51 obtains the path information about all the paths connected to the virtual machine 50 configured by the guest OS 51 itself by sending an inquiry to the path management program 21 for the host OS 40 (SP91). For example, in the case of the virtual machine 50 with the ID “VM1,” the guest OS 51 obtains information about all the entries whose “VM” field 22A stores “VM1” in the first path management table 22.

Next, the guest OS 51 selects one path whose path ID is contained in the path information obtained in SP91 (SP92). Also, the guest OS 51 reads the path status of that path from the path information obtained in SP92 (SP93), and then judges whether the path status of the path is “offline” or not (SP94).

If SP94 returns a negative judgment (SP94: NO), the guest OS 51 proceeds to SP96. On the other hand, if SP94 returns an affirmative judgment (SP94: YES), the guest OS 51 blocks the path by changing the path status stored in the “path status” field 26E for the entry corresponding to that path in the second path management table 26 from “online” to “offline” (SP95).

Subsequently, the guest OS 51 judges, based on the path information obtained in SP91, whether or not the processing from SP92 to SP95 has been executed for all the paths connected to the virtual machine 50 configured by the guest OS 51 itself (SP96).

If SP96 returns a negative judgment (SP96: NO), the guest OS 51 returns to SP92 and then sequentially select another path to be selected in SP92 and repeats the processing from SP92 to SP95.

If SP96 returns an affirmative judgment (SP96: YES) by eventually finishing executing the processing from SP92 to SP95 for all the paths connected to the virtual machine 50 configured by the guest OS 51 itself, the guest OS 51 proceeds to SP97.

Then, the guest OS 51 notifies the path management program 21 of termination of the resume processing on the guest OS 51 itself (SP97).

After receiving the resume termination notice, the path management program 21 returns the correspondence relationship between the physical HBA and the virtual HBA, which was changed in SP81 in FIG. 17, back to the original correspondence relationship.

For example, the path management program 21 changes the physical HBA “Y” associated with the virtual HBA “X1” to the physical HBA “X” in the first path management table 22. Then, the CPU 10 changes the physical HBA allocated to the virtual HBA “X1” from “X” to “Y.”

The guest OS 51 obtains the path information about all the paths connected to the virtual machine 50 configured by the guest OS 51 itself by sending an inquiry to the path management program 21 for the host OS 40 (SP98).

The guest OS 51 changes the information stored in the physical HBA 26C for the entry corresponding to the relevant path in the second path management table 26, from “Y” to “X.”

As a result, the processing interrupted before the hibernation is executed immediately after resuming the virtual machine 50, so that the occurrence of an I/O delay due to the path failure can be prevented.

(3-9) Display of Path Block Information

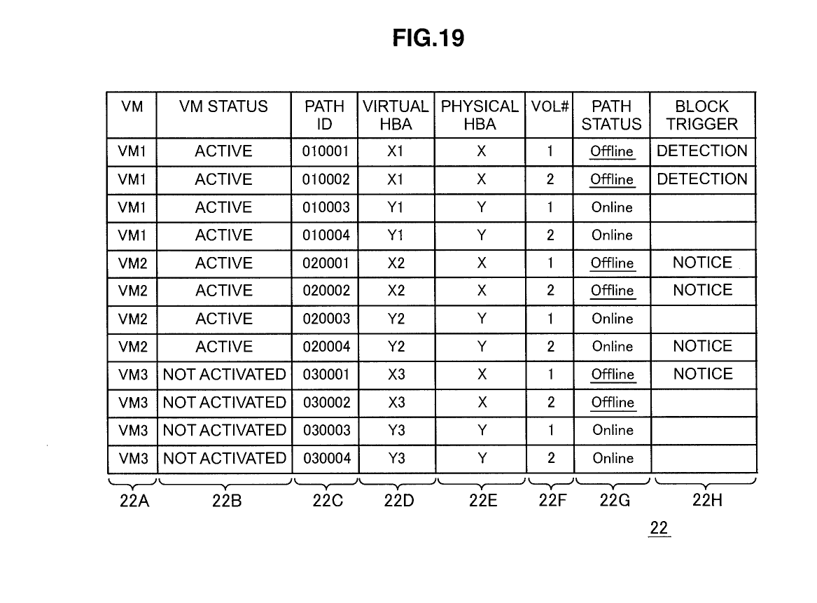

The physical computer 2 or the management computer 7 can display a path block trigger for each virtual machine 50. FIG. 19 shows an example.

If the path redundant program 25 for the virtual machine 50 detects a failure and blocks a path for its own virtual machine 50, that fact is displayed. Referring to FIG. 19, “detection” is displayed in a “block trigger” field 22H. If the path redundant program for another virtual machine 50 detects a failure and the relevant path is blocked after receiving notice from the path management program 21, that fact is displayed. Referring to FIG. 19, “notice” is displayed in the “block trigger” field 22H. Furthermore, logs of the block trigger information about the virtual machine 50 may be displayed in text.

### (4) Effects of This Embodiment

If any virtual machine 50 detects a path failure in the virtual computer system 1 according to this embodiment described above, the virtual machine 50 notifies the path management program 21 for the host OS 40 to that effect; and in response to this notice, the path management program 21 notifies each virtual machine 50 that a path routed through the same physical HBA 13 through which the path where the failure has occurred is routed should be blocked; and in response to this notice, the corresponding path in each virtual machine 50 is blocked. Therefore, I/O drive of all the virtual machines 50 will not be suppressed by the failure which occurred in the physical HBA 13, and the impact of the failure in the physical HBA 13 on the entire virtual computer system 1 can be reduced. As a result, a highly-reliable computer apparatus and path management method can be realized.

### (5) Other Embodiments

The above-described embodiment has described the case where a plurality of guest-side path management units that are provided so that they are associated with a plurality of the virtual machines 50, respectively, and each guest-side path management unit manages the path status of paths connected to each corresponding virtual machine 50, are constituted from the CPU (FIG. 1) for controlling the operation of the entire physical computer 2, and the path redundant program 25; however, the configuration of the invention is not limited to this example, and a dedicated CPU for the guest-side path management units may be provided.

Similarly, the aforementioned embodiment has described the case where the host-side path management unit for consolidating the management of the path status in the plurality of virtual machines 50 is constituted from the CPU for controlling the operation of the entire physical computer 2, and the path redundant program 25; however, the configuration of the invention is not limited to this example, and a dedicated CPU for the host-side path management unit may be provided.

Furthermore, the aforementioned embodiment has described the case where a plurality of physical I/O devices shared by a plurality of virtual computers are physical HBAs 13; however, the configuration of the invention is not limited to this example, and the present invention can also be used in the case where the physical I/O devices are, for example, other types of physical I/O devices such as NICs 12.

What is claimed is:

1. A computer apparatus that provides a virtual environment and is connected to a storage apparatus having a storage area, the computer apparatus comprising:
a virtual computer providing unit for providing a plurality of virtual computers, each having a virtual HBA;
a plurality of first path management units provided in such a manner that they are associated with the plurality of virtual computers, respectively, and each first path management unit manages the status of the virtual HBA belonging to its corresponding virtual computer;
a plurality of physical HBAs that are shared by the plurality of virtual computers and correspond to the virtual HBAs; and
a second path management unit for managing a correspondence relationship between the virtual HBAs belonging to the plurality of virtual computers and the plurality of physical HBAs;
wherein if the first path management unit detects a failure in the virtual HBA, it notifies the second path management unit of the failure; and
in response to the failure notice, the second path management unit gives an instruction to the first path management unit corresponding to each virtual computer having another virtual HBA that uses the physical HBA corresponding to the virtual HBA in which the failure has been detected, to block the other virtual HBA; and
if the first path management unit receives the instruction from the second path management unit to block the virtual HBA, it blocks the designated virtual HBA.

2. The computer apparatus according to claim 1, wherein if the second path management unit detects recovery of the physical HBA in which the failure occurred, it gives an instruction to the first path management unit corresponding to each virtual computer having the virtual HBA corresponding to the recovered physical HBA to recover that virtual HBA; and
if the first path management unit receives the instruction from the second path management unit to recover the virtual HBA, it recovers the designated virtual HBA corresponding to the recovered physical HBA.

3. The computer apparatus according to claim 2, wherein during processing for activating the corresponding virtual computer, the first path management unit inquires of the second path management unit about the status of the physical HBA corresponding to the virtual HBA for the relevant virtual computer and then manages the obtained status of the physical HBA; and blocks the virtual HBA corresponding to the physical HBA in which the failure occurred.

4. The computer apparatus according to claim 1, wherein if the virtual computer is to become inactive, the first path management unit notifies the second path management unit that the virtual computer will become inactive; and
wherein in response to the failure notice, the second path management unit changes the correspondence relationship between the physical HBA in which the failure was detected, and the virtual HBA for the virtual computer which becomes inactive, to the correspondence relationship between the physical HBA which belongs to the computer apparatus and in which no failure is detected, and the virtual HBA for the inactive virtual computer corresponding to the physical HBA in which the failure was detected; and
wherein if the inactive virtual computer is to be reactivated,
the first path management unit notifies the second path management unit of reactivation, and
in response to the reactivation notice, the second path management unit gives an instruction to the first path management unit corresponding to the reactivated virtual computer to block the virtual HBA corresponding to the physical HBA in which the failure was detected; and
wherein if the first path management unit receives the instruction from the second path management unit to block the virtual HBA, it blocks the designated virtual HBA, and
the second path management unit associates the blocked virtual HBA with the physical HBA in which the failure was detected.

5. The computer apparatus according to claim 1, wherein if the first path management program detects the failure and blocks the virtual HBA in which the failure has been detected, the computer apparatus displays that the failure has been detected and the faulty virtual HBA has been blocked; and
If the first path management program receives notice of the failure from the second path management program and blocks the virtual HBA corresponding to the physical HBA in which the failure has been detected, the computer apparatus displays that the notice of the failure has been received and the relevant virtual HBA has been blocked.

6. A path management method for a computer apparatus that provides a virtual environment and is connected to a storage apparatus having a storage area, the computer apparatus comprising:
a virtual computer providing unit for providing a plurality of virtual computers, each having a virtual HBA;
a plurality of first path management units provided in such a manner that they are associated with the plurality of virtual computers, respectively, and each first path management unit manages the status of the virtual HBA belonging to its corresponding virtual computer;
a plurality of physical HBAs that are shared by the plurality of virtual computers and correspond to the virtual HBAs; and
a second path management unit for managing a correspondence relationship between the virtual HBAs belonging to the plurality of virtual computers and the plurality of physical HBAs;
wherein if the first path management unit detects a failure in the virtual HBA, it notifies the second path management unit of the failure;
in response to the failure notice, the second path management unit gives an instruction to the first path management unit corresponding to each virtual computer having another virtual HBA that uses the physical HBA corresponding to the virtual HBA in which the failure has been detected, to block the other virtual HBA; and
if the first path management unit receives the instruction from the second path management unit to block the virtual HBA, it blocks the designated virtual HBA.

7. The computer apparatus path management method according to claim 6, wherein if the second path management unit detects recovery of the physical HBA in which the failure occurred, it gives an instruction to the first path management unit corresponding to each virtual computer having the virtual HBA corresponding to the recovered physical HBA to recover that virtual HBA; and
if the first path management unit receives the instruction from the second path management unit to recover the virtual HBA, it recovers the designated virtual HBA corresponding to the recovered physical HBA.

8. The computer apparatus path management method according to claim 7, wherein during processing for activating the corresponding virtual computer, the first path management unit inquires of the second path management unit about the status of the physical HBA corresponding to the virtual HBA for the relevant virtual computer and then manages the obtained status of the physical HBA; and blocks the virtual HBA corresponding to the physical HBA in which the failure occurred.

9. The computer apparatus path management method according to claim 6, wherein if the virtual computer is to become inactive, the first path management unit notifies the second path management unit that the virtual computer will become inactive; and
wherein in response to the failure notice, the second path management unit changes the correspondence relationship between the physical HBA in which the failure was detected, and the virtual HBA for the virtual computer which becomes inactive, to the correspondence relationship between the physical HBA which belongs to the computer apparatus and in which no failure is detected, and the virtual HBA for the inactive virtual computer corresponding to the physical HBA in which the failure was detected; and
wherein if the inactive virtual computer is to be reactivated,
the first path management unit notifies the second path management unit of reactivation, and
in response to the reactivation notice, the second path management unit gives an instruction to the first path management unit corresponding to the reactivated virtual computer to block the virtual HBA corresponding to the physical HBA in which the failure was detected; and
wherein if the first path management unit receives the instruction from the second path management unit to block the virtual HBA, it blocks the designated virtual HBA, and
the second path management unit associates the blocked virtual HBA with the physical HBA in which the failure was detected.
